(19) United States
(12) Patent Application Publication
(10) Pub. No.: US 2014/0340594 A1
(43) Pub. Date: Nov. 20, 2014

(54) TOUCH PANEL AND TOUCH PANEL DISPLAY USING THE SAME

(71) Applicant: InnoLux Corporation, Miao-Li County (TW)

(72) Inventor: Chen-Wei CHANG, Miao-Li County (TW)

(73) Assignee: InnoLux Corporation, Miao-Li County (TW)

(21) Appl. No.: 14/267,036

(22) Filed: May 1, 2014

(30) Foreign Application Priority Data
May 14, 2013 (TW) 102117025

(51) Int. Cl. G06F 3/041

(52) U.S. Cl. CPC G06F 3/041
USPC 349/12

(57) ABSTRACT

The present invention relates to a touch panel and a touch panel display using the same. The touch panel includes: a substrate; a patterned shielding layer disposed on the substrate; an optical adjustment layer disposed on the patterned shielding layer; and a patterned circuit layer disposed on the optical adjustment layer, wherein the patterned circuit layer and the patterned shielding layer are staggered in a direction parallel to the a normal vector of a plane of the substrate.

### CROSS REFERENCE TO RELATED APPLICATION

This application claims the benefits of the Taiwan Patent Application Serial Number 102117025, filed on May 14, 2013, the subject matter of which is incorporated herein by reference.

### BACKGROUND OF THE INVENTION

1. Field of the Invention

The present invention relates to a touch panel, and more particularly, to a transparent touch panel featured by an invisible circuit pattern.

2. Description of Related Art

The demand for miniaturization and lightweight of electronic devices is increasing with the development of technology. To satisfy the market demand, there have been many attempts to integrate the interior configuration of electronic devices. For example, the touch sensing layer may be embedded in the display panel to decrease the number of layers in the configuration to satisfy the demand for miniaturization and lightweight.

In the above example of touch panel displays, there have been attempts to integrate the touch panel circuits on the glass substrate of the display panel to realize miniaturization and lightweight. However, the circuit formed on the glass substrate is typically made of a transparent conductive material, such as indium tin oxide (ITO) or indium zinc oxide (IZO), which has a refractive index difference from that of the transparent substrate. As a result, the circuit area and the non-circuit area on the glass substrate may be easily distinguished by naked eyes due to the difference in refractive indices, thus affecting the overall transparent appearance.

In view of the above problems, it is desirable to develop a touch panel, which can not only reduce the visibility of the transparent circuit, but also enhance the viewing quality of its appearance.

### SUMMARY OF THE INVENTION

An object of the present invention is to provide a touch panel, particularly a transparent touch panel characterized by an invisible circuit pattern, such that the circuit area and the non-circuit area on the touch panel are not recognizable for naked eyes. The invention can also be applied to any touch panel.

Another object of the present invention is to provide a touch display panel using the above touch panel, to improve the quality of its appearance.

To achieve the above object, the present invention provides a touch panel, including: a substrate; a patterned shielding layer disposed on the substrate; an optical adjustment layer disposed on the patterned shielding layer, wherein a product of a thickness and a refractive index of the optical adjustment layer is 1.00 μm or more; and a patterned circuit layer disposed on the optical adjustment layer, wherein the patterned circuit layer and the patterned shielding layer are staggered in a direction parallel to a normal vector of a plane of the substrate.

To achieve another object, the present invention provides a touch display panel, including: a display panel; and a touch panel disposed on one side of the display panel, wherein the touch panel comprises: a substrate; a patterned shielding layer disposed on the substrate; an optical adjustment layer disposed on the patterned shielding layer, wherein a product of a thickness and a refractive index of the optical adjustment layer is greater than or equal to 1.00 μm and less than or equal to 320 μm; and a patterned circuit layer disposed on the optical adjustment layer, wherein the patterned circuit layer and the patterned shielding layer are staggered in a direction parallel to a normal vector of a plane of the substrate.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows a touch panel of the first example of the present invention.

FIG. 2 shows a touch panel of the comparative example of the present invention.

FIG. 3 shows the reflectivity spectrum of the touch panel of the first example in FIG. 1 and the touch panel of the comparative example in FIG. 2.

FIG. 4 shows the transmission spectrum of the touch panel of the first example in FIG. 1 and the touch panel of the comparative example in FIG. 2.

FIG. 5 shows the reflectivity spectrum of touch panel of the first example at various view angles.

FIG. 6 shows the transmission spectrum of touch panel of the first example at various view angles.

FIG. 7 shows a touch panel of the second example of the present invention.

FIG. 8 shows a touch panel of the third example of the present invention.

FIG. 9 shows a touch panel of the fourth example of the present invention.

FIG. 10 shows a touch display panel according to the example of the present invention.

FIG. 11 shows a touch display panel according to the example of the present invention.

### DETAILED DESCRIPTION OF THE PREFERRED EMBODIMENT

The present invention will now be explained in further detail with reference to the following examples. However, these examples are merely illustrative of the present invention, the scope of which shall not be construed to be limited by the following examples.

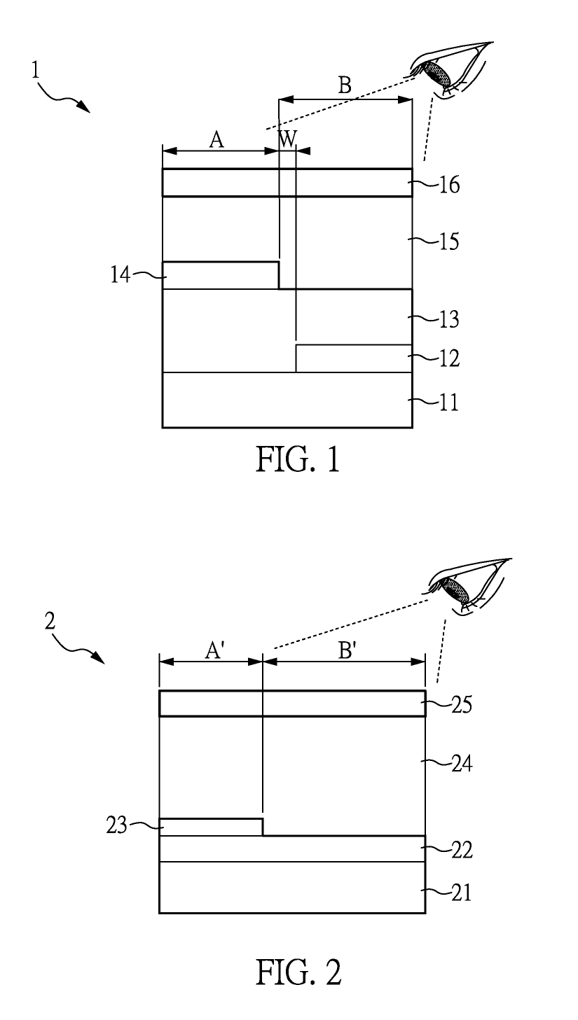

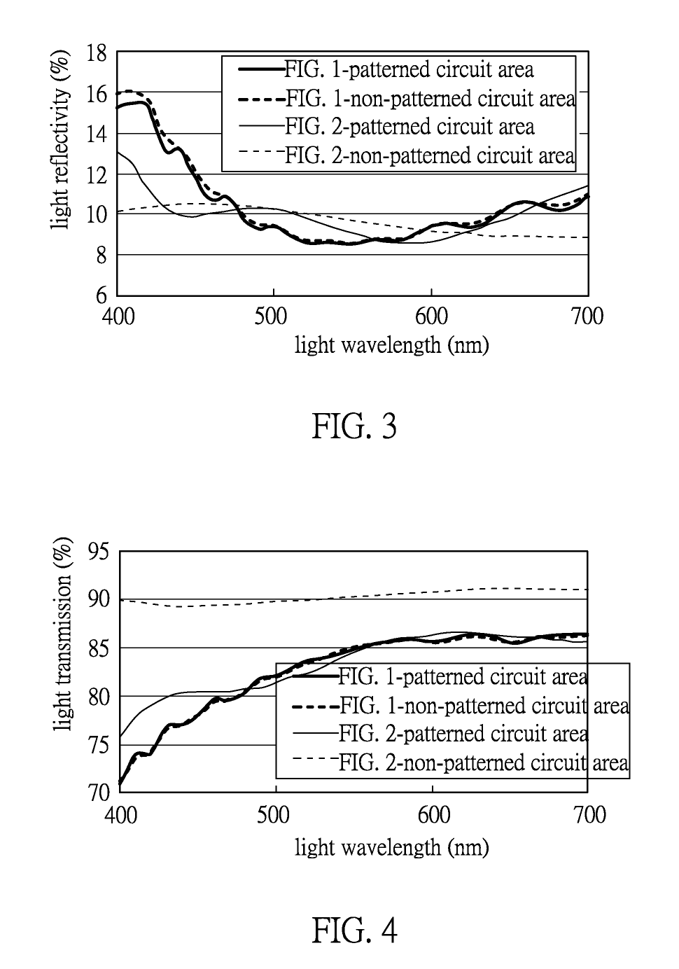

FIG. 1 shows a touch panel 1 of the first example of the present invention. The touch panel 1 is prepared by providing a substrate 11 having a thickness of 0.5 mm and a refractive index of 1.51; forming a patterned shielding layer 12 having a thickness of 136.2 nm and a refractive index of 2.00 on the substrate 11; then, forming an optical adjustment layer 13 on the patterned shielding layer 12; then, forming a patterned circuit layer 14 having a thickness of 136.2 nm and a refractive index of 2.00 on the optical adjustment layer 13, wherein the projections of the patterned shielding layer 12 and the patterned circuit layer 14 on the substrate 11 did not overlap; then, sequentially laminating an adhesive layer 15 having a thickness of 25 μm and a refractive index of 1.49 and a protection layer 16 having a thickness of 50 μm and a refractive index of 1.51 on the patterned circuit layer 14, to complete the touch panel 1 of the first example. In this example, the adhesive layer 15 may be made of an optical clear adhesive (OCA), and the protection layer 16 may be an anti-splinted film (ASF). In order to enhance anti-reflection or anti-glare effect, the protection layer 16 may further comprise an anti-reflection layer (not shown) or an anti-glare layer (not shown). In the touch panel 1, in the direction perpendicular to the plane of the substrate 11, the area having the patterned circuit layer 14 is defined as the patterned circuit area A, and the area not having the patterned circuit layer 14 is defined as the non-patterned circuit area B.

Basically, in the conventional glass substrate with a patterned circuit layer, the patterned circuit area and the non-patterned circuit area on the glass substrate may be easily distinguished by naked eyes due to the difference in refractive indices between the patterned circuit and the glass substrate, thus affecting the appearance of the glass substrate. To reduce the visibility of the patterned circuit on the glass substrate to thereby achieve an invisible patterned circuit, in the touch panel 1 of the first example, the patterned shielding layer 12 having the same refractive index and/or light absorption rate with the patterned circuit layer 14 is formed on the non-patterned circuit area B, and the patterned shielding layer 12 and the patterned circuit layer 14 are separated by the optical adjustment layer 13, making the optical interference of the upper and lower interfaces negligible. In this case, the patterned circuit area A and the non-patterned circuit area B respectively on the upper and the lower interfaces of the optical adjustment layer 13 are hardly distinguishable by naked eyes due to consistency in refractive index and/or light absorption rate, thus achieving an invisible patterned circuit.

In order to make the optical interference of the upper and lower interfaces of the optical adjustment layer 13 negligible, the thickness of the optical adjustment layer 13 should be selected to satisfy the inequality: L1≧λ²/(2×N1×ΔX), wherein, L1 is the thickness of the optical adjustment layer 13, N1 is the refractive index of the optical adjustment layer 13, λ is the mean wavelength of the wavelength range, and ΔX is the full width at half maximum (FWHM) of the wavelength. In the visible light wavelength range of 400-700 nm, the product of the thickness L1 and refractive index N1 of the optical adjustment layer 13 is L1×N1≧[550²/(2×150)]nm, i.e. L1×N1 is greater than or equal to approximately 1 μm. In other words, when the product of the thickness L1 and refractive index N1 of the optical adjustment layer 13 is greater than or equal to 1 μm, the optical interference of the upper and the lower interfaces of the optical adjustment layer 13 is negligible.

On the premise that the above inequality is met, the thickness of the optical adjustment layer 13 of this Example can be optimized according to the different refractive index, as shown in Table 1:

TABLE 1

| | Visible light | FWHM of the | Thickness of the |
|---|---|---|---|
| | wavelength | wavelength | optical adjustment |
| Refractive index | λ (nm) | Δλ (nm) | layer L1 (nm) |
| 1.4 | 550 | 150 | 720.2 |
| 1.6 | 550 | 150 | 630.2 |
| 1.8 | 550 | 150 | 560.2 |
| 2.0 | 550 | 150 | 504.2 |
| 2.2 | 550 | 150 | 458.3 |
| 2.4 | 550 | 150 | 420.1 |

Taking the optical adjustment layer 13 having a refractive index of 1.55 as an example, it can be calculated from the above equation that the thickness should be greater than 0.67 μm, preferably 0.67-200 μm, more preferably 1-100 μm, and most preferably 1-10 μm. If the optical adjustment layer 13 is too thin, or too close to 0.67 μm, it would be difficult to achieve the invisibility of the patterned circuit, or an adverse effect may occur due to process variation. However, if the thickness of the optical adjustment layer 13 is too thick, when the touch panel 1 is observed obliquely, the overlapping area of the patterned circuit layer 14 and the patterned shielding layer 12 may be readily observable, thus reducing the effect of invisibility. A preferable invisibility of the circuit may be achieved when the product of the thickness and refractive index of the optical adjustment layer 13 is greater than or equal to 1.00 μm and less than or equal to 320 μm.

In the above-described touch panel 1 of FIG. 1, in the direction perpendicular to the plane of the substrate 11, the projections of the patterned shielding layer 12 and the patterned circuit layer 14 on the substrate 11 do not overlap, that is, the patterned circuit layer 14 and the patterned shielding layer 12 are staggered in a direction parallel to the normal vector of a plane of the substrate 11. The distance W between projections of the patterned shielding layer 12 and the patterned circuit layer 14 on the substrate 11 may be 0-10 μm, and preferably 1-5 μm. If the distance W is too large, the gap between the patterned circuit layer 14 and the patterned shielding layer 12 may be readily observable; however, if the distance W is too small, the overlapping between the patterned circuit layer 14 and the patterned shielding layer 12 may be readily observable due to the change of viewing angle (relative to the normal vector), thereby reducing the effect of invisibility of the patterned circuit layer 14.

The refractive index of each layer of the touch panel 1 of FIG. 1 may be properly adjusted according to different requirements, and not limited to the aforementioned refractive index. In a preferable case, the optical adjustment layer 13 and the substrate 11 have a similar refractive index, and a difference in refractive index between the substrate 11 and the optical adjustment layer is 0-0.1, and preferably 0-0.05. Specifically, the refractive index of the optical adjustment layer 13 may be 1.4-1.6, and preferably 1.45-1.55. Moreover, the thickness of each layer of the touch panel 1 may be properly adjusted according to different requirements.

In order to highlight the effect of invisibility of the patterned circuit layer 14, another touch panel structure is provided for comparison, as shown in FIG. 2.

In FIG. 2, the touch panel 2 is prepared by providing the same substrate 21 having a thickness of 0.5 mm and a refractive index of 1.51 as in FIG. 1; forming an index matching layer 22 having a thickness of 200 nm and a refractive index of 1.71 on the substrate 21; then, forming a patterned circuit layer 23 having a thickness of 136.2 nm and a refractive index of 2.00 on the index matching layer 22; and finally, sequentially forming an optical adhesive layer 24 having a thickness of 25 μm and a refractive index of 1.49 and a protection layer 25 having a thickness of 50 μm and a refractive index of 1.51 on the patterned circuit layer 23 and the index matching layer 22, to complete the touch panel 2 of FIG. 2. In the touch panel 2, in the direction perpendicular to the plane of the substrate 11, the area having the patterned circuit layer 23 is defined as the patterned circuit area A′, and the area not having the patterned circuit layer 23 is defined as the non-patterned circuit area B′.

The touch panel 1, 2 in FIG. 1 and FIG. 2 are analyzed for the optical characteristics, such as reflectivity and transmission. The reflectivity and transmission spectra of the patterned circuit areas A, A′ and the non-patterned circuit areas B, B′ in FIG. 1 and FIG. 2 are measured respectively, and the results are shown in FIG. 3, FIG. 4 and Table 2:

TABLE 2

| | | Reflected | | Transmitted | | Light |
|---|---|---|---|---|---|---|
| | | light | | light | | absorption |
| | | R_Y | ΔE_R | T_Y | ΔE_T | rate |
| Touch panel 1 | A | 8.98% | — | 84.63% | — | 6.62% |
| | B | 9.04% | — | 84.61% | — | 6.61% |
| | Δ | 0.06% | 0.51 | 0.02% | 0.07 | 0.01% |
| Touch panel 2 | A′ | 9.25% | — | 84.43% | — | 6.4% |
| | B′ | 9.65% | — | 90.33% | — | 0.05% |
| | Δ | 0.4% | 1.28 | 5.9% | 3.52 | 6.35% |

Please refer to FIG. 3 and Table 2, in the visible light wavelength range, taking the mean value of 550 nm as an example, the reflectivity (R_Y) and reflected light chromaticity difference (ΔE_R) of the patterned circuit areas A, A′ and the non-patterned circuit areas B, B′ of the touch panels 1, 2 in FIG. 1 and FIG. 2 are observed respectively. The chromaticity difference (ΔE_R) is obtained by converting visible light to CIE1976 color space, which is well known to persons skilled in the art, and will not be described in detail herein. The reflectivity of the touch panel 1 of FIG. 1 in the patterned circuit area A is 8.98%, while that in the non-patterned circuit area B is 9.04%, and the difference in the light reflectivity between these two areas is 0.06%. In addition, the reflected light chromaticity difference is 0.51. The reflectivity of the touch panel 2 of FIG. 2 in the patterned circuit area A′ is 9.25%, while that in the non-patterned circuit area B′ is 9.65%, and the difference in the light reflectivity between the two areas is 0.4%. In addition, the reflected light chromaticity difference is 1.28. In addition, from the results shown in FIG. 3, it can be found that in the visible light wavelength range of 400-700 nm, the difference in the light reflectivity between the patterned circuit area A and the non-patterned circuit area B of the touch panel 1 of FIG. 1 is significantly smaller than that between the patterned circuit area A′ and the non-patterned circuit area B′ of the touch panel 2 of FIG. 2.

In general, when the difference in the light transmission or the light reflectivity between two areas is less than 0.5%, the difference in brightness is hardly recognizable with the naked eye to distinguish the two areas. Further, when the chromaticity difference between the two areas is less than 3, the chromaticity difference between the two areas will not be noticeable by the naked eye. Thus, in the visible light wavelength range, the difference in the light reflectivity and the reflected light chromaticity difference of FIG. 1 are far less than the recognizable level for the naked eye. Hence, compared to the configuration of FIG. 2, the patterned circuit area A and the non-patterned circuit area B of the configuration of FIG. 1 are less recognizable by the naked eye.

Please refer to FIG. 4 and Table 2, in the visible light wavelength range, taking the mean value of 550 nm as an example, the light transmission (T_Y) and the transmitted light chromaticity difference (ΔT_R) of the patterned circuit areas A, A′ and the non-patterned circuit areas B, B′ of the touch panels 1, 2 in FIG. 1 and FIG. 2 are observed respectively. The light transmission of the touch panel 1 of FIG. 1 in the patterned circuit area A is 84.63%, while that in the non-patterned circuit area B is 84.61%, and the difference in the light transmission between the two areas is 0.02%. In addition, the transmitted light chromaticity difference is 0.07. The light transmission of the touch panel 2 of FIG. 2 in the patterned circuit area A′ is 84.43%, while that in the non-patterned circuit area B′ is 90.33%, and the difference in the light transmission between the two areas is 5.9%. In addition, the transmitted light chromaticity difference is 3.52. In addition, from the results shown in FIG. 4, it can be found that in the visible light wavelength range of 400-700 nm, the difference in the light transmission between the patterned circuit area A and the non-patterned circuit area B of the touch panel 1 of FIG. 1 is significantly smaller than that between the patterned circuit area A′ and the non-patterned circuit area B′ of the touch panel 2 of FIG. 2.

Comparing to the aforementioned difference in the light transmittance or the light reflectivity (less than 0.5%) and the transmitted light chromaticity difference or the reflected light chromaticity difference (less than 3), in the visible light wavelength range of 400-700 nm, in the configuration of FIG. 1, the difference in the light transmittance and the transmitted light chromaticity difference are far less than the recognizable level for the naked eye. However, in the configuration of FIG. 2, the difference in the light transmittance and the transmitted light chromaticity difference do not fall within unrecognizable level to the naked eye. In other words, the difference between the patterned circuit area A′ and the non-patterned circuit area B′ of the configuration in FIG. 2 can be easily distinguished by the naked eye, but the difference between the patterned circuit area A and the non-patterned circuit area B of the configuration in FIG. 1 is less recognizable by the naked eye. Clearly, the configuration of FIG. 1 provides superior invisibility of circuit than that of FIG. 2.

Furthermore, according to Table 2, the difference in the light absorption rate between the patterned circuit area A and the non-patterned circuit area B in FIG. 1 is 0.01%, far less than that in the light absorption rate between the patterned circuit area A′ and the non-patterned circuit area B′ of 6.35% in FIG. 2, which further demonstrates the unrecognizable feature of FIG. 1. Accordingly, the configuration of FIG. 1 provides superior invisibility of circuit than that of FIG. 2.

The results of FIG. 3, FIG. 4 and Table 2 indicate that the touch panel 2 of FIG. 2 merely achieves the compensation for the difference in reflected light, but the touch panel 1 in FIG. 1 may achieve the compensations for the differences in transmitted light, absorbed light, and reflected light simultaneously. Therefore, the patterned circuit area A and the non-patterned circuit area B in the configuration of FIG. 1 is more hardly distinguishable by the naked eye, and has more excellent effect on the invisibility of circuit.

In addition , by the same optical film simulation software Macleod, the reflected light spectrum, the transmitted light spectrum, and the chromaticity difference of the patterned circuit area A and the non-patterned circuit area B of FIG. 1 are observed at various viewing angles in the visible light wavelength range of 400-700 nm.

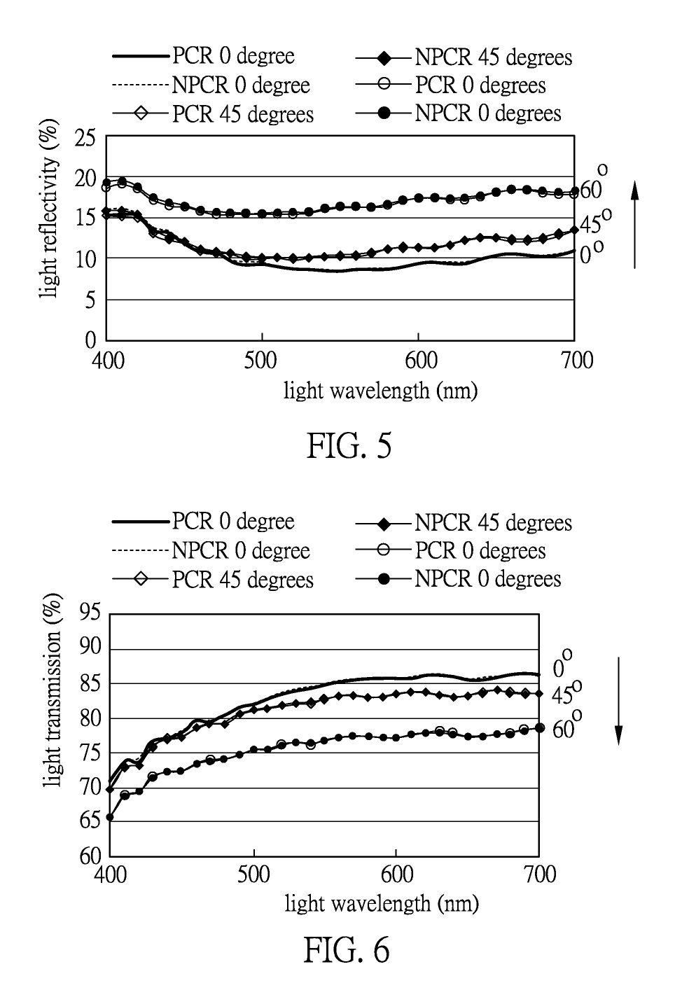

Here, the viewing angle of 0 degree is defined with respect to the normal line of the touch panel 1, and the viewing angles for detection in the examples are 0 degree, 45 degrees, 60 degrees, respectively. FIG. 5 is the reflectivity spectrum, and FIG. 6 is the transmission spectrum. In the reflectivity spectrum of FIG. 5, although the light reflectivity of the patterned circuit area A and the non-patterned circuit area B observed at different viewing angles increases with the increase of the viewing angle, the reflectivity spectra of the patterned circuit area A and the non-patterned circuit area B almost overlap with tiny difference at the same viewing angle. Furthermore, in the transmission spectrum of FIG. 6, although the transmitted light of the patterned circuit area A and the non-patterned circuit area B observed at different viewing angles decreases with the increase of the viewing angle, the reflectivity spectra of the patterned circuit area A and the non-patterned circuit area B almost overlap with tiny difference at the same viewing angle. The results of FIG. 5 and FIG. 6 indicate that in the visible light wavelength range, the touch panel 1 in FIG. 1 show almost no difference in the reflectivity spectrum and the transmission spectrum of the patterned circuit area A and the non-patterned circuit area B at different viewing angles.

Furthermore, the transmitted light chromaticity difference and the reflected light chromaticity difference of the patterned circuit area A and the non-patterned circuit area B of the touch panel 1 in FIG. 1 are measured at various viewing angles, and the results are shown in Table 3:

TABLE 3

| | Property | | | | | |
|---|---|---|---|---|---|---|
| Item | Transmitted light | | | Reflected light | | |
| Viewing angle | 0 | 45 | 60 | 0 | 45 | 60 |
| (degree) | | | | | | |
| Chromaticity | 0.1 | 0.1 | 0.1 | 0.5 | 0.4 | 0.2 |
| difference | | | | | | |
| between areas A | | | | | | |
| and B | | | | | | |

According to Table 3, in spite of different viewing angles, the transmitted and reflected light chromaticity differences in the areas A and B of the touch panel in FIG. 1 are all much smaller than the recognizable level for the naked eye (i.e. far less than 3), indicating that the difference between the patterned circuit area A and the non-patterned circuit area B of the touch panel 1 in FIG. 1 are unrecognizable by the naked eye even at different viewing angles. In other words, the touch panel 1 in FIG. 1 has more excellent effect on the invisibility of circuit.

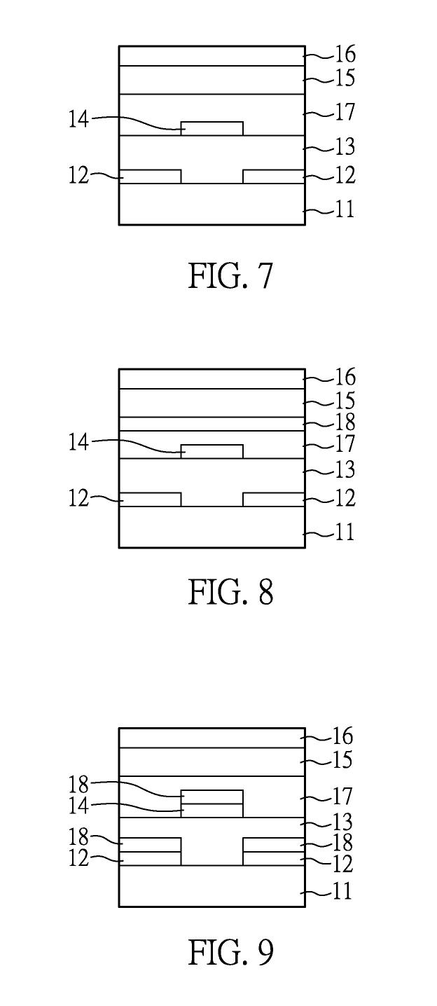

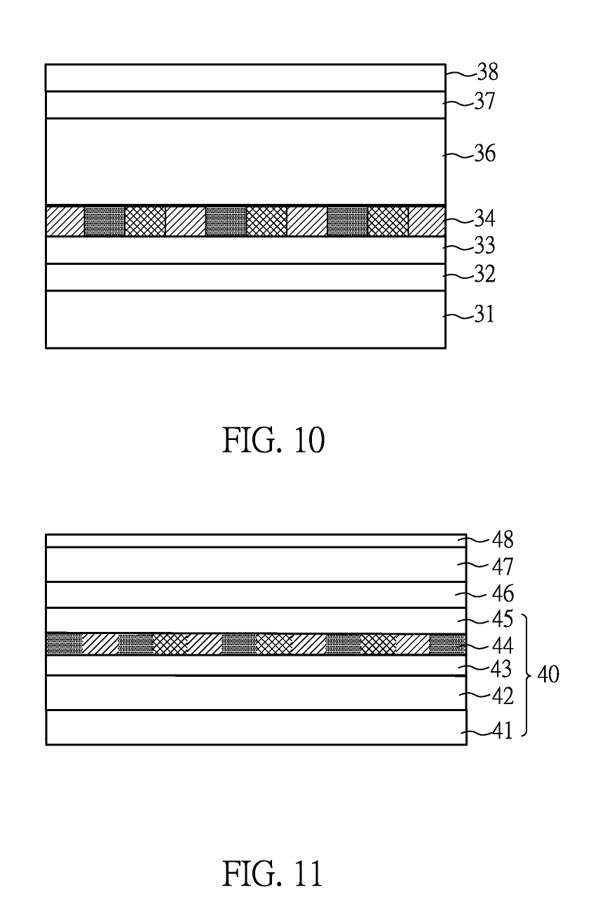

In addition to the example of FIG. 1 above, The present invention further comprises a second example of FIG. 7, a third example of FIG. 8, and the fourth example of FIG. 9, which will be described in detail below.

Please refer to FIG. 7. The configuration of FIG. 7 is substantially the same as that of FIG. 1, except that in FIG. 7, an optical protection layer 17 is further formed between the patterned circuit layer 14 and the optical adhesive layer 15 thereby protecting the patterned circuit layer 14, as well as preventing interference between adjacent films to improve invisibility of the patterned circuit layer 14. The product of the thickness and refractive index of the optical protection layer 17 is greater than or equal to 1.00, and preferably greater than or equal to 1.0083. In the preferable case, the thickness of the optical protection layer 17 is between 0.67-200 μm, preferably between 1-100 μm, and most preferably between 1-10 μm. Further, the refractive index of the optical protection layer 17 preferably is 1.4-1.6, and more preferably 1.45-1.55. In the more preferable case, the material and the thickness of the optical protection layer 17 are the same as that of the optical adjustment layer 13. Likewise, a preferable invisibility of the circuit may be achieved when the product of the thickness and refractive index of the optical protection layer 17 is greater than or equal to 1.00 μm and less than or equal to 320 μm.

Referring to FIG. 8, the configuration of FIG. 8 is substantially the same as that of FIG. 7 to achieve the same invisibility of circuit, except that in FIG. 8, a dielectric film having various reflectivity is formed between the optical protection layer 17 and the optical adhesive layer 15 to form a reflective index matching layer 18, so as to adjust the overall light transmittance of the touch panel.

In this case, the number of layers of the index matching layer 18 is not particularly limited and may be a single layer or a plurality of layers. The thickness of the index matching layer 18 may be controlled by the coating time, and its crystallinity, composition ratio, and porosity, etc., which may be altered by adjusting the process conditions, in order to adjust the refractive index of the index matching layer 18. Preferably, the index matching layer 18 has a thickness of less than or equal to 300 nm.

The index matching layer 18 may be made of silicon oxynitride (SiOxNy, refractive index=1.71), silicon dioxide (SiO₂, refractive index=1.45-1.47), magnesium fluoride (MgF₂, refractive index=1.38), aluminum oxide (Al₂O₃, refractive index=1.65-2.2), niobium pentoxide (Nb₂O₅, refractive index=2.1-2.3), titanium dioxide (TiO₂, refractive index=2.2-2.5), etc., which can be formed by sputtering or evaporation. In addition, silicon dioxide (SiO₂, refractive index=1.45-1.47) may also be formed by a wet coating method such as dip-coating, but the present invention is not limited thereto.

In addition, referring to FIG. 9, the configuration of FIG. 9 is substantially the same as that of FIG. 8, except that in FIG. 9, the index matching layer 18 is formed on the patterned shielding layer 12 and the patterned circuit layer 14 respectively to improve the overall light transmittance of the touch panel. Here, the condition of the index matching layer 18 is the same as that in FIG. 8 to achieve the same effect on the invisibility of circuit.

The touch panel of the present invention can be applied to any device requiring a transparent touch panel and not particularly limited to, for example, a car display, a touch panel, electromagnetic isolation glass, a cellular phone, a solar cell, a portable LCD video game, a home appliance LCD panel, a display for an instrument, an organic light emitting diode display, a liquid crystal display, a notebook computer, a liquid crystal television, a plasma display, an electrode for a color filter, a combination thereof, and so on.

In the case of the touch panel, for example, FIG. 10 illustrates an embedded (on-cell) touch panel display formed by sequentially laminating a lower substrate 31, an active element array layer 32, a liquid crystal layer 33, a color filter layer 34, a touch panel 36, a polarization layer 37 and an upper substrate 38, wherein various functional layers may be optionally introduced between the layers, without particular limitation. The touch panel 36 may be any one of the touch panels of the configurations in FIGS. 1, and 7-9 of the present invention, without particular limitation. Here, the touch panels of FIGS. 1, and 7-9 are the same as described above, and the detail will not be repeated here for brevity.

Please refer to FIG. 11, which illustrates a plug-in (out-cell) touch panel display including a display panel 40 and a touch panel 47, wherein the touch panel 47 is formed on the display panel 40, and the display panel is formed by sequentially laminating a lower substrate 41, an active element array layer 42, a liquid crystal layer 43, a color filter layer 44, and a polarization layer 45, wherein various functional layers may be optionally introduced between the layers without particular limitation. In FIG. 11, the touch panel 47 of the present invention may include any one of the touch panels of the configurations in FIGS. 1, and 7-9 according to the present invention, the touch panel 47 is connected to the display panel by an adhesive layer 46, and a hard coating 48 is further included in the touch panel 47.

It should be understood that these examples are merely illustrative of the present invention and the scope of the invention should not be construed to be defined thereby, and the scope of the present invention will be limited only by the appended claims.

What is claimed is:

1. A touch panel, comprising:
a substrate;
a patterned shielding layer disposed on the substrate;
an optical adjustment layer disposed on the patterned shielding layer, wherein a product of a thickness and a refractive index of the optical adjustment layer is greater than or equal to 1.00 μm and less than or equal to 320 μm; and
a patterned circuit layer disposed on the optical adjustment layer, wherein the patterned circuit layer and the patterned shielding layer are staggered in a direction parallel to a normal vector of a plane of the substrate.

2. The touch panel of claim 1, wherein the thickness of the optical adjustment layer is 0.67-200 μm.

3. The touch panel of claim 1, wherein a difference in refractive index between the substrate and the optical adjustment layer is 0-0.1.

4. The touch panel of claim 1, wherein the refractive index of the optical adjustment layer is 1.4-1.6.

5. The touch panel of claim 1, wherein the patterned shielding layer and the patterned circuit layer have identical refractive index or light absorption rate.

6. The touch panel of claim 1, wherein a distance between projections of the patterned shielding layer and the patterned circuit layer on the substrate is 1-5 μm.

7. The touch panel of claim 1, further comprising an optical protection layer disposed on the patterned circuit layer, wherein a product of a thickness and a refractive index of the optical protection layer is greater than or equal to 1.00 μm and less than or equal to 320 μm.

8. The touch panel of claim 7, further comprising at least one refractive index matching layer disposed on the optical protection layer or on the patterned shielding layer and the patterned circuit layer.

9. The touch panel of claim 8, wherein the refractive index matching layer has a thickness of 300 nm or less.

10. A touch panel display, comprising:
a display panel; and
a touch panel disposed on one side of the display panel, wherein the touch panel comprises:
a substrate;
a patterned shielding layer disposed on the substrate;
an optical adjustment layer disposed on the patterned shielding layer, wherein a product of a thickness and a refractive index of the optical adjustment layer is greater than or equal to 1.00 μm and less than or equal to 320 μm, and
a patterned circuit layer disposed on the optical adjustment layer, wherein the patterned circuit layer and the patterned shielding layer are staggered in a direction parallel to a normal vector of a plane of the substrate.
